(19) United States
(12) Patent Application Publication
(10) Pub. No.: US 2025/0268371 A1
(43) Pub. Date: Aug. 28, 2025

(54) FURNITURE SYSTEM AND METHOD FOR POWER DISTRIBUTION IN A FURNITURE SYSTEM

(71) Applicant: LOGICDATA Electronic & Software Entwicklungs GmbH, Deutschlandsberg (AT)

(72) Inventor: Haymo Niederkofler, Graz (AT)

(21) Appl. No.: 18/857,579

(22) PCT Filed: Apr. 3, 2023
(86) PCT No.: PCT/EP2023/058617

§ 371 Date: Oct. 17, 2024

(30) Foreign Application Priority Data
Apr. 19, 2022 (DE) 10 2022 109 425.1

(51) Int. Cl. A47B 21/02; A47B 9/20; H02J 1/10; H02J 7/34

(52) U.S. Cl. CPC A47B 21/02; A47B 9/20; H02J 1/106; H02J 7/34; A47B 2200/0082; H02J 2310/12

(57) ABSTRACT

A furniture system with at least one electrically adjustable part comprises one or more components for electrical adjustment, at least one internal power supply unit, an internal network for connecting the one or more components, and a power distributor. The power distributor comprises at least one internal interface to the internal network, at least one external interface for connecting an external power source, and a controller unit which is configured to demand-based control of one or more energy flows between the internal power supply unit, the internal network and the at least one external interface. The power distributor is configured to supply the components for electrical adjustment from the internal power supply unit and from the one external power source, both individually and in combination.

The invention relates to a furniture system with components for electrical adjustment and a method for power distribution in such a furniture system.

In the prior art, furniture, such as workstation tables for the office sector, or mobile trolleys for the medical sector, but also sofas, are known which provide interfaces for the power supply of consumers, lighting, and other devices.

For example, such a conventional furniture system comprises a power supply unit connected to a wall socket, and interfaces in the form of sockets mounted on or in the furniture system, which supply the mains voltage or a DC low voltage derived from the mains voltage to consumers and devices connected to it.

In the prior art, furniture is also known that supplies the energy for the power supply of the interfaces from an energy storage device in the form of a battery or rechargeable battery, so that the furniture does not have to be constantly plugged into a wall socket and a power supply unit, but can be mobile.

For example, these may be single-column tables or computer trolleys such as those commonly used in the medical sector. In order to be able to supply medical devices or computers connected to an interface on the single-column table with energy even if there is no mains voltage, an energy storage device mounted on or in the table is used, which is only supplied with energy from the mains voltage on a case-by-case basis.

One objective to be achieved is to specify an improved supply concept for a furniture system that enables more flexible and efficient energy distribution.

This objective is achieved by the subject matter of the independent patent claims. Further developments and embodiments are characterized in the dependent claims.

A furniture system comprises one or more components for electrical adjustment of at least one adjustable part of the furniture system and an internal network for connecting the one or more components, in particular electrically.

The components for electrical adjustment can be formed, for example, by linear actuators comprising a motor, gearbox, and spindle-nut system.

The components for electrical adjustment can, for example, adjust height-adjustable parts of a furniture system in the form of table legs or table columns. For example, a single-column table can comprise a telescopic column as a table leg with a linear actuator integrated into the column.

Alternatively, a table can also comprise any number of table columns, each of which comprises a linear actuator that moves synchronously, i.e. simultaneously and in the same way. For example, a table can comprise a height-adjustable tabletop with 2 or 4 table columns that move synchronously with each other.

Further components for electrical adjustment are, for example, one or more handswitches or displays, as well as motor controls for the motors of the linear actuators.

The furniture system also comprises at least one internal power supply unit. The power supply unit can be a plug-in power supply unit, for example. Typically, the power supply unit is designed for the power required for typical operation of the piece of furniture, e.g. 65 watts continuous power.

The improved supply concept is based on the finding that with a power distributor, which is characterized by at least one internal interface to the internal network and one or more external interfaces for connecting external power sources, the furniture system can additionally or alternatively be supplied with power from the external power sources. Optionally, external consumers can also be supplied with power from the furniture system. With such a power distributor, the available internal and external power can be used flexibly by both internal and external consumers of a furniture system or made available from internal or external power sources.

The power distributor therefore also comprises a controller unit that is set up to control one or more energy flows between the internal power supply unit, the internal network and the at least one external interface as required.

The power distributor is configured, for example through the controller unit, to supply the components for electrical adjustment from the internal power supply unit and from the external power source, if this is connected to the at least one external interface, both individually and in combination. In particular, the sources are chosen selectively, for example based on the respective energy requirement and/or the available energy.

The power distributor can also comprise one or more further external interfaces for connecting a further external power source and can be configured to supply the components for electrical adjustment additionally or alternatively from the one further external power source if the one further external power source is connected to the at least one further external interface.

The external interfaces are implemented, for example, as bidirectional interfaces for connecting external loads and/or power sources that are external to the furniture system.

The power distributor can also have one or more external unidirectional interfaces for connecting external consumers that are not part of the furniture system.

The power distributor can, for example, be implemented as an independent component with its own housing, or be part of another component of the furniture system, e.g. integrated in a handswitch or in a motor control unit.

A unidirectional interface allows energy to flow from the furniture system to a consumer connected to a unidirectional interface.

A unidirectional interface comprises at least lines for transmitting electrical energy.

In a further embodiment, a unidirectional interface comprises a bidirectional data connection. This data connection can be used, for example, to establish communication between the power distributor and the consumer and to provide characteristics of the consumer, information about the power required by the consumer or information about the power that the power distributor can or does provide for the consumer.

Bidirectional interfaces allow energy to flow from the furniture system to consumers that are connected to a bidirectional interface. In contrast to a unidirectional interface, a bidirectional interface also allows energy to flow from an external or non-furniture system power source, e.g. a power bank, a laptop battery, or a laptop power supply unit, to the furniture system. This means that an internal energy storage device can be dispensed with, for example, or it can be made smaller. This can save weight for the furniture system.

The energy flow from an external power source occurs, for example, when the furniture system's own internal power supply unit cannot supply enough or any power at all to adjust the furniture system, e.g. in the event of a mains voltage failure, a defect in the power supply unit or particularly high loads on the furniture system.

For example, energy can also flow from an external power source if the furniture system requires more power than the furniture system's own internal power supply unit can supply. This occurs when a furniture system is subjected to an extraordinary load and electrical adjustment is still required. In this case, the power from the external power source and the power from the power supply unit are combined and the combined power is used for electrical adjustment.

A bidirectional interface comprises, for example, lines for bidirectional transmission of electrical energy or power.

In a further embodiment, a bidirectional interface comprises a bidirectional data connection. As with the unidirectional interface, this data connection can be used, for example, to establish communication between the power distributor and the consumer and to exchange characteristics of the consumer, information about the desired power required by the consumer or information about the power that the power distributor can or does provide for the consumer. In addition, the data connection can also be used, for example, to exchange characteristics about the available power of the external power source.

In a further embodiment, the power distributor may select the energy flow direction of the bidirectional interface. The direction of energy flow can be directed from the furniture system to an external load, or from an external power source to the furniture system.

In a further embodiment, the power distributor may determine the level of energy flow provided via the bidirectional interface. The level of an energy flow is, for example, a power or a current at a given voltage.

In a further embodiment, the power distributor may have a combination of bidirectional interfaces and unidirectional interfaces for energy transmission. If unidirectional interfaces are present, the power distributor may also determine the level of energy flow provided via the unidirectional interface(s).

In a further embodiment, one or more external power sources, each connected to a bidirectional interface, may be combined to form the furniture's own internal power supply unit, or may be used in place of the furniture's own internal power supply unit.

In a further embodiment, a consumer at a bidirectional or unidirectional interface may be a device or an energy storage device that is charged by the furniture system via the power distributor.

In a further embodiment, the potential energy stored in one or more adjustable parts of the furniture system, e.g. in a raised tabletop, may be used as an energy source in a furniture system with high system efficiency. For example, in a table system with high system efficiency, a large part of the potential energy is released when the tabletop is lowered and can be distributed by the power distributor to consumers at a unidirectional or bidirectional output, e.g. to a battery connected to it.

In another separate embodiment, the furniture system may have its own energy storage device, e.g. in the form of a capacitor, which is dimensioned in such a way that it can absorb the potential energy. This can be done, for example, if no energy storage device is connected to one of the unidirectional or bidirectional interfaces. The energy storage device of the furniture system can, for example, be realized as an independent component of the furniture system or be integrated in the power distributor.

### Description of the Possible Energy Flows:

The use of a power distributor in a furniture system makes various forms of energy flows possible, which offer the user of a furniture system equipped in this way advantages over the previous state of the art.

In one embodiment, a load may be supplied with power from the furniture's own power supply unit at a unidirectional interface.

In a further embodiment, a load may be supplied with power from the furniture's own power supply unit at a bidirectional interface.

In a further embodiment, the electrical components for adjustment may be supplied with power from one or more energy sources at bidirectional interfaces.

In a further embodiment, one or more loads at unidirectional interfaces may be supplied with power from one or more external power sources at bidirectional interfaces.

In a further embodiment, one or more loads at bidirectional interfaces may be supplied by one or more external power sources at bidirectional interfaces.

For example, the following case could occur: There is a laptop and another medical device on a computer trolley. When the battery of the computer trolley is empty, the medical device no longer works, while the laptop still works due to its built-in battery. In this case, it is possible that the laptop's battery will at least temporarily power the device connected to the table's interfaces.

In summary, a furniture system with a power distributor can use all currently available power sources, e.g. internal power supply unit, external power supply units of laptops, power banks, potential etc. stored in adjustable parts of the furniture system on the one hand for electrical adjustment of the furniture system and on the other hand make them available to other consumers in order to operate or charge them.

The power distributor comprises a controller unit which, for example, has a decision control unit that decides the direction and level of one or more energy flows depending on the situation.

In one embodiment, the power distributor may use power from the furniture's own power supply unit to charge or supply external devices when, for example, the furniture system is not being adjusted.

In another embodiment, the power distributor may use power from the furniture's own power supply unit to charge and supply external devices while the furniture system is being adjusted, in which case the power provided via the unidirectional or bidirectional interfaces is reduced.

In a further embodiment, the power distributor may use the potential energy or position energy of one or more adjustable parts of the furniture system as an energy source and store it in an energy store at a unidirectional or bidirectional interface or in an energy store of the furniture system and, for example, use it again later for an adjustment. Potential energy or positional energy refers to the ability of an adjustable part of the furniture system to perform mechanical work due to its position. Potential energy is a form of mechanical energy.

In a further embodiment, the power distributor may request power from energy sources at bidirectional interfaces if the furniture's own power supply unit is unable to supply any or sufficient power, e.g. in the event of a mains voltage failure or a defective power supply unit, or if the furniture's own power supply unit is currently unavailable.

In a further embodiment, the power distributor may enable several energy flows in different directions, so that, for example, an energy flow from the furniture's own power supply unit and an energy flow from an external power supply unit are used together both for adjusting the furniture system and for charging external devices.

In another embodiment, the power distributor can negotiate the power provided by external power sources. For example, a “contract” can be concluded between the power distributor and a power supply unit connected via a bidirectional interface, such as a laptop power supply unit, regarding the power to be supplied.

In a further embodiment, the power distributor can negotiate the energy requested by external consumers. For example, a contract can be concluded between the power distributor and a consumer connected via a unidirectional or bidirectional interface regarding the power supplied by the furniture system.

The power distributor includes, for example, a control unit for combining, e.g. parallel switching of several energy sources. This allows the power distributor to utilize the power of several energy sources depending on the situation and use it either to adjust the furniture and/or to supply external devices. For example, if more power is required than the furniture system's own power supply unit provides, the missing power can be supplemented by external power sources.

In one embodiment, the power distributor may combine the furniture's own power supply unit with one or more energy sources at bidirectional interfaces.

In another embodiment, the power distributor may combine several power sources at bidirectional interfaces and not use the furniture's own power supply unit.

The furniture system further comprises the internal network that electrically connects, for example, the components for electrical adjustment, the internal power supply unit, and the power distributor.

The internal network may be a power bus, for example. The internal network allows, for example, the transmission of energy, but also bidirectional communication between the components connected to the network, such as the power distributor, the components for electrical adjustment and the internal power supply unit.

The power distributor has one or more internal interfaces to the internal network. The number of interfaces depends, among other things, on the topology of the internal network or on whether the power distributor is connected to the network as an independent component or is part of another component of the furniture system.

One aspect of the improved supply concept comprises a method for power distribution in a furniture system according to one of the described embodiments.

The method comprises the following steps:
a. Determining, e.g. summarizing, a momentary total power demand of all loads connected to the internal network, in particular the components for electrical adjustment of the table system,
b. Determining a power available from the internal power supply unit,
c. Determining the available power of one or more connected external power sources, and
d. Supplying the loads connected to the internal network with combined power from the internal power supply unit and from the connected external power sources if the determined available power from the internal power supply unit is lower than the determined total power demand and if a sum of the determined available power from the internal power supply unit and the external power sources is higher than the determined total power demand.

Further embodiments of the method result from the various possible uses of the power distributor described above, in particular with regard to the possible energy flows.

For example, the power distributor is equipped with a controller unit for carrying out the process in accordance with the improved supply concept.

The improved supply concept is explained in more detail below with reference to the drawings using examples of embodiments. Similar elements or elements with the same functions are designated with the same reference signs. Therefore, a repeated explanation of individual elements is not necessary.

It shows:

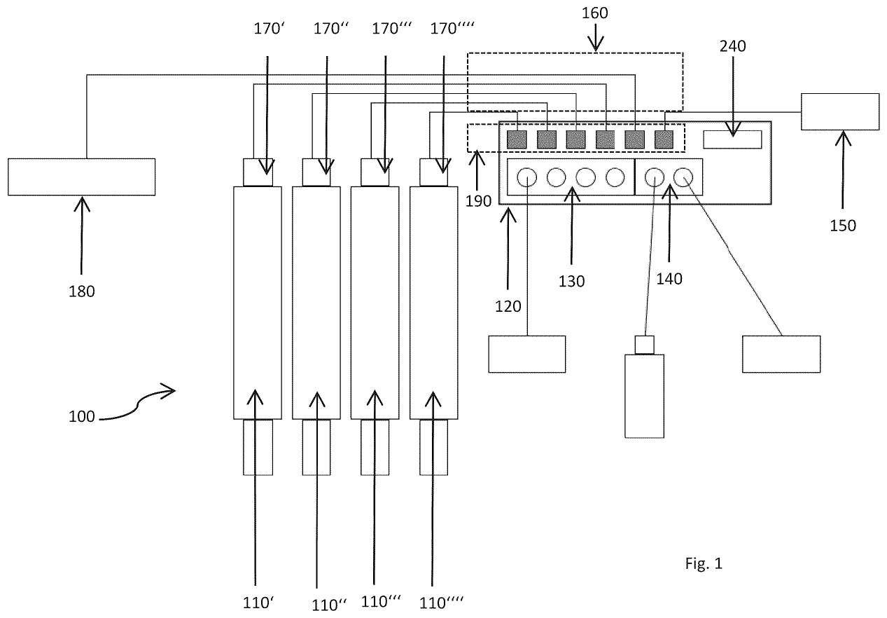

FIG. 1 a furniture system;

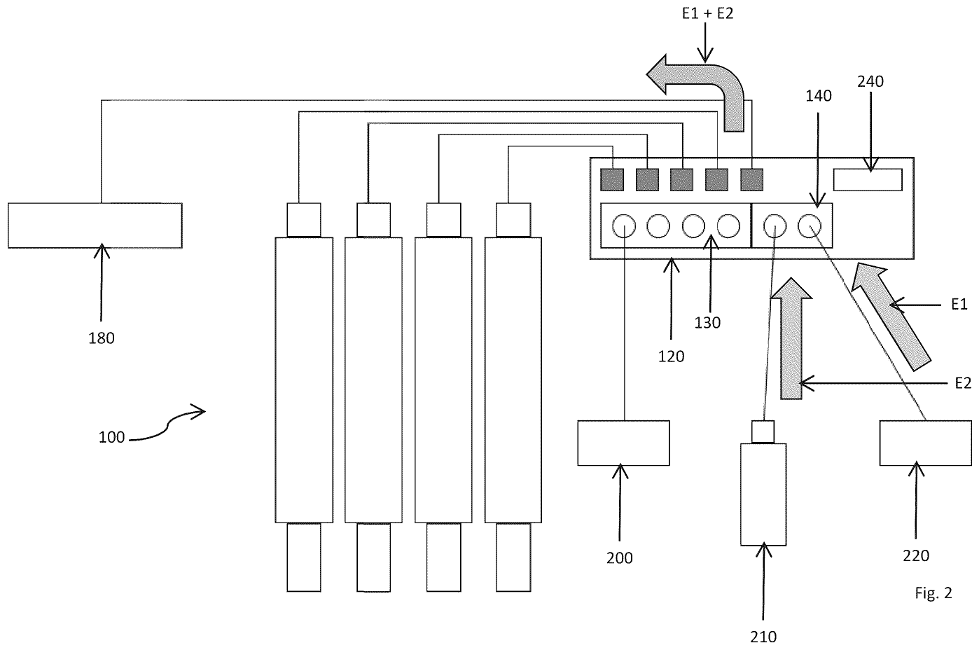

FIG. 2 a furniture system fed by combined energy flows from two energy sources;

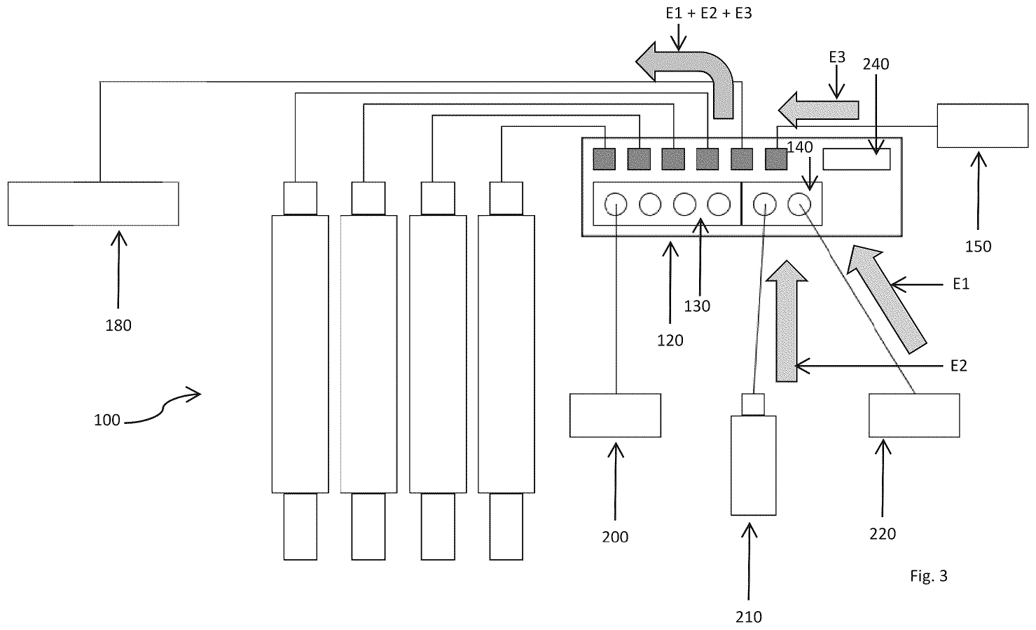

FIG. 3 a furniture system fed by combined energy flows from three energy sources;

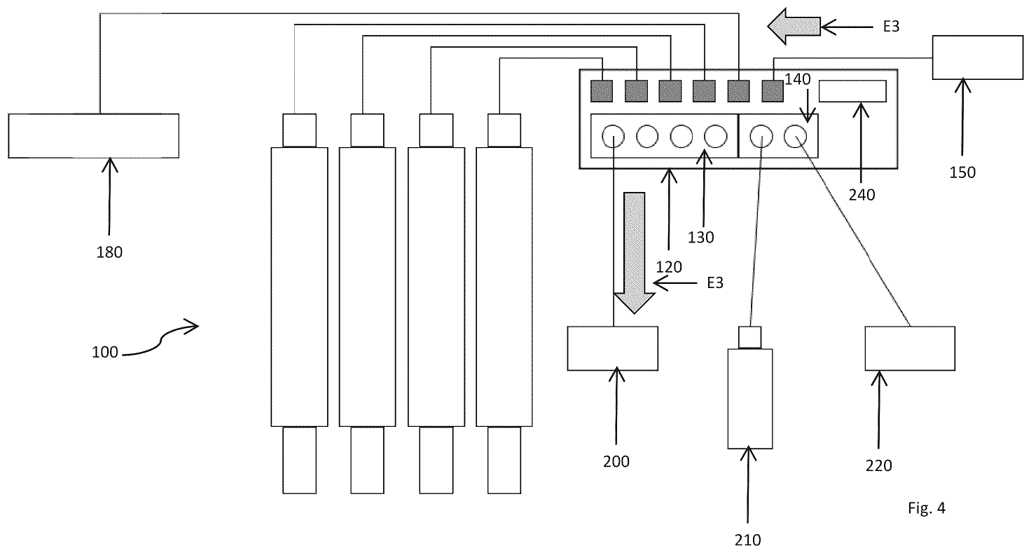

FIG. 4 a furniture system that feeds an external load at a unidirectional interface through the furniture's own power supply unit;

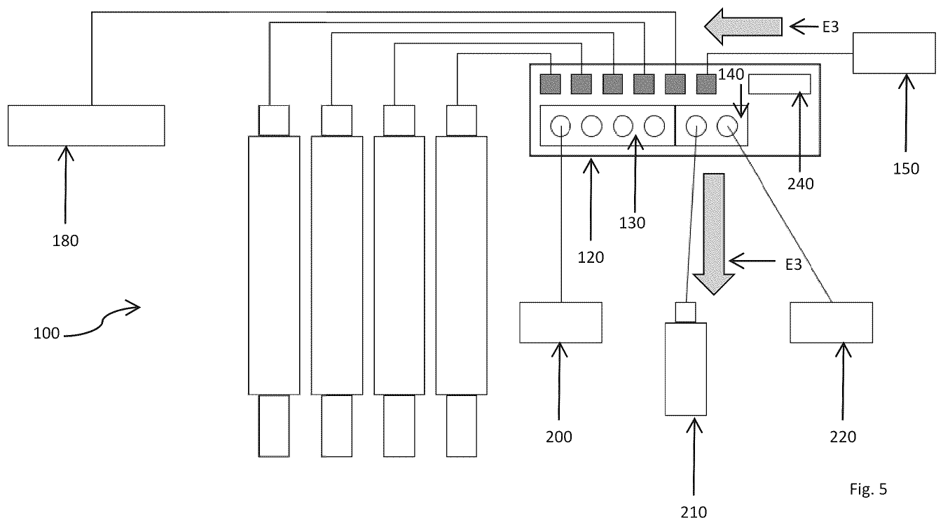

FIG. 5 a furniture system that feeds an external load at a bidirectional interface through the furniture's own power supply unit;

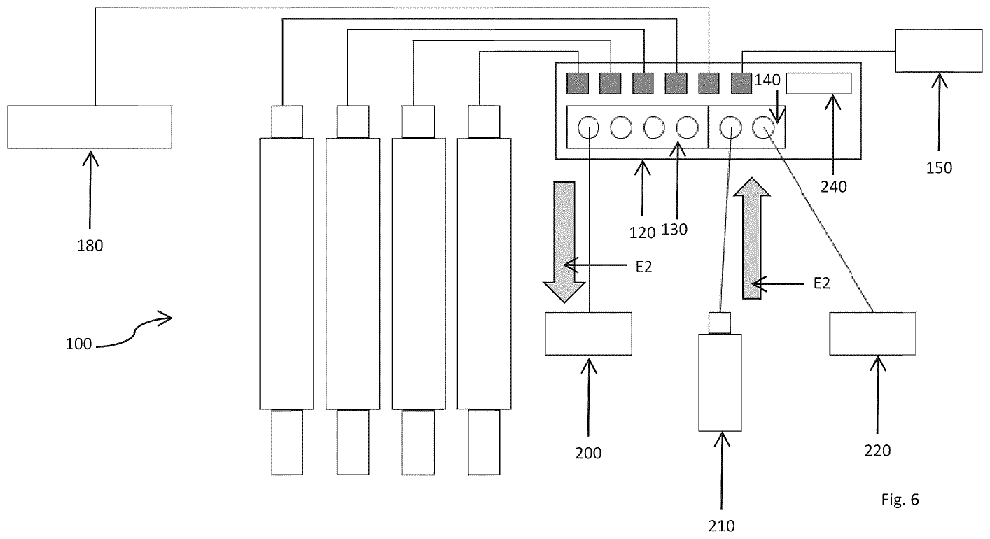

FIG. 6 a furniture system that feeds an external load at a unidirectional interface through a power source at a bidirectional interface;

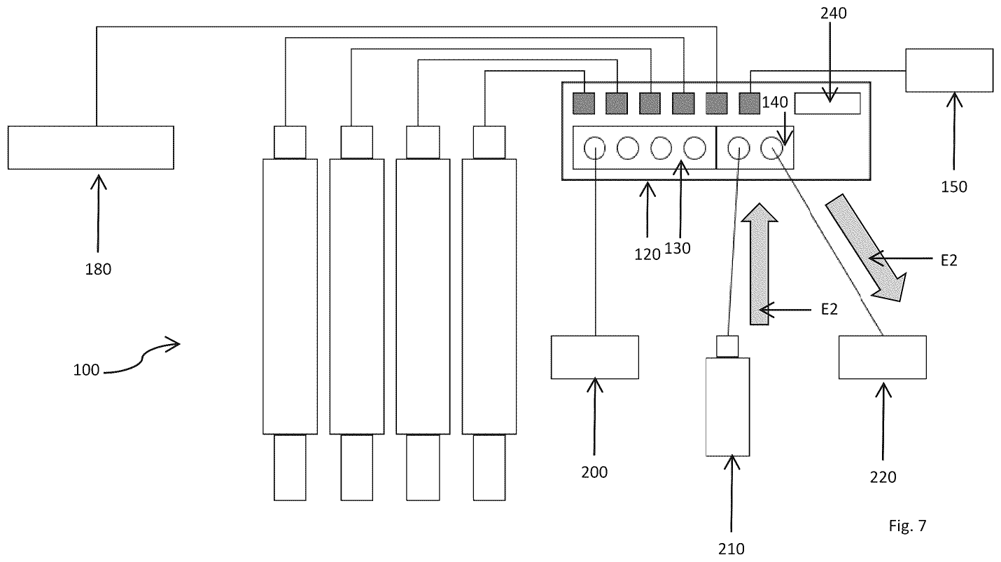

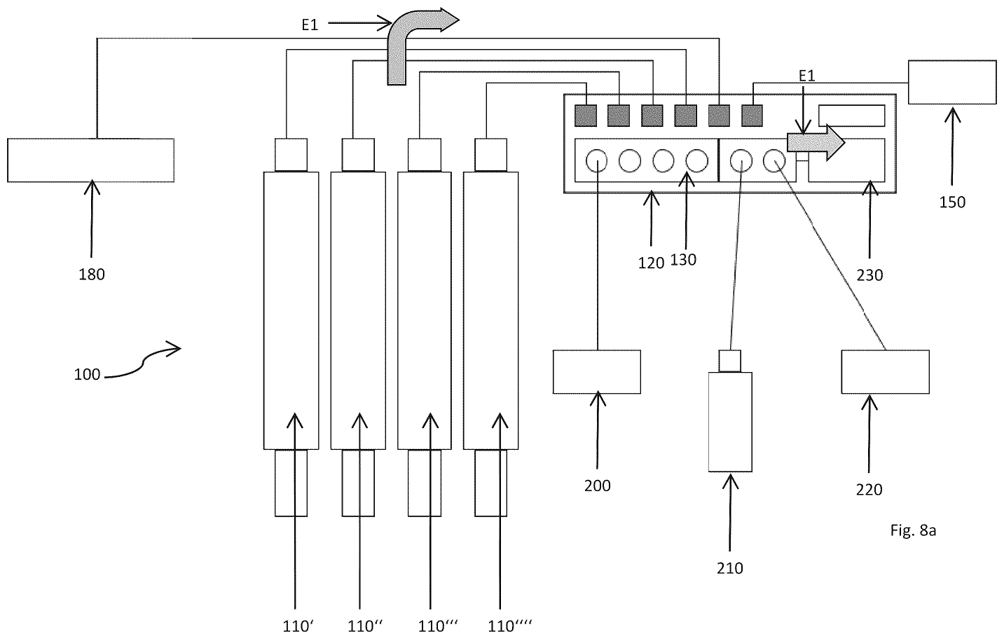

FIG. 7 a furniture system that feeds an external load at a bidirectional interface through a power source at a bidirectional interface;

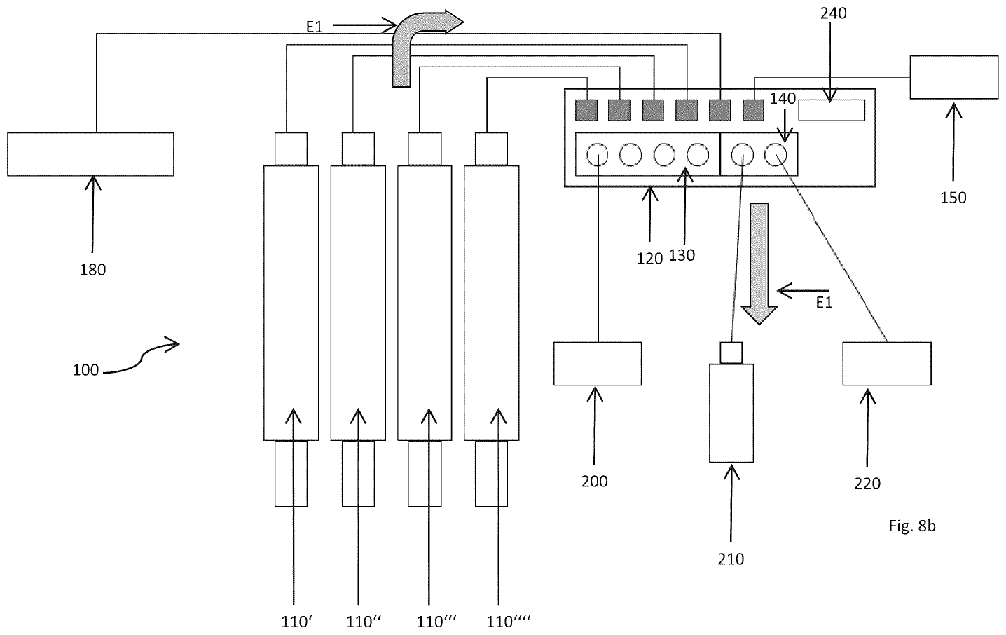

FIG. 8 a furniture system that uses the potential energy in an adjustable component as an energy source;

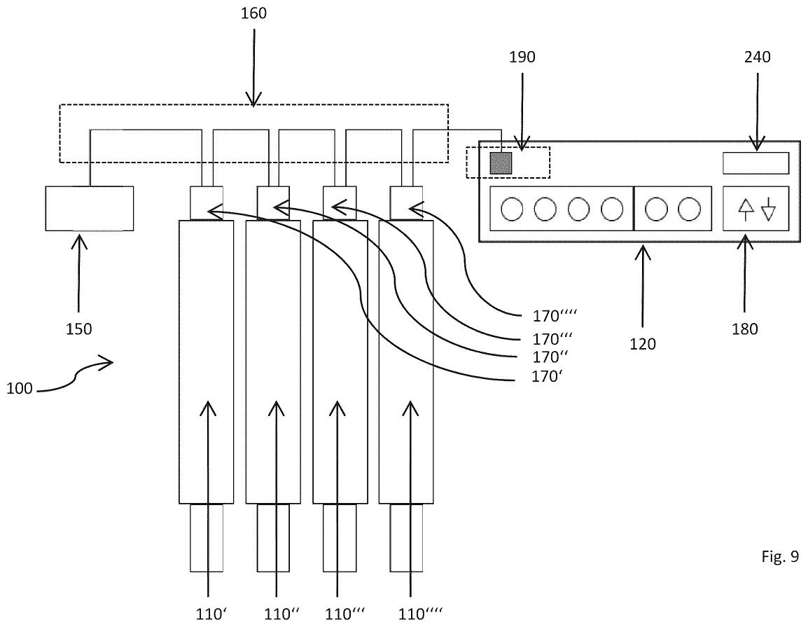

FIG. 9 a furniture system with an internal network that has a line topology, where the power distributor and handswitch form a single unit;

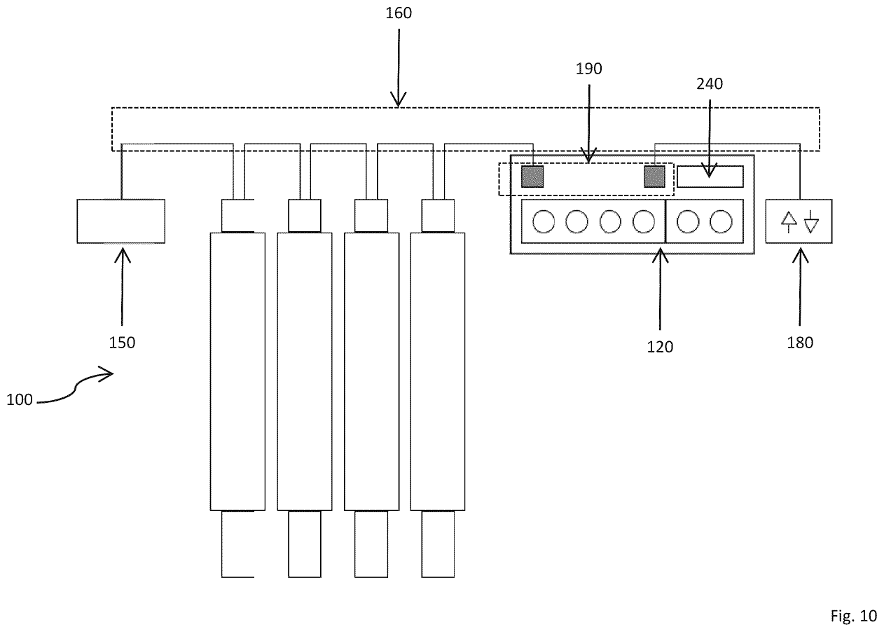

FIG. 10 a furniture system with an internal network having a line topology, where the power distributor and handswitch are separate;

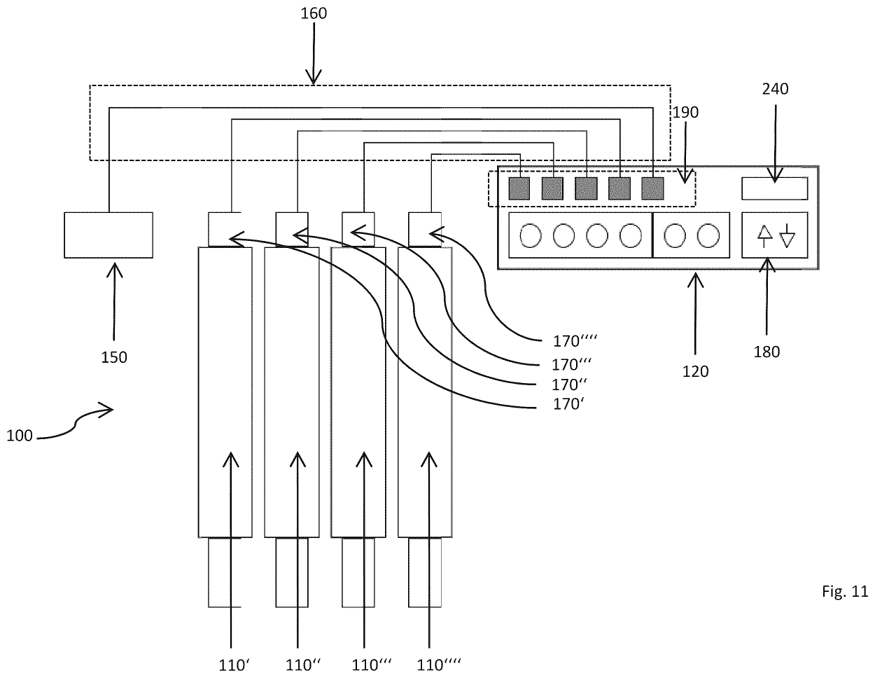

FIG. 11 a furniture system with an internal network that has a star topology, where the power distributor and handswitch form a unit;

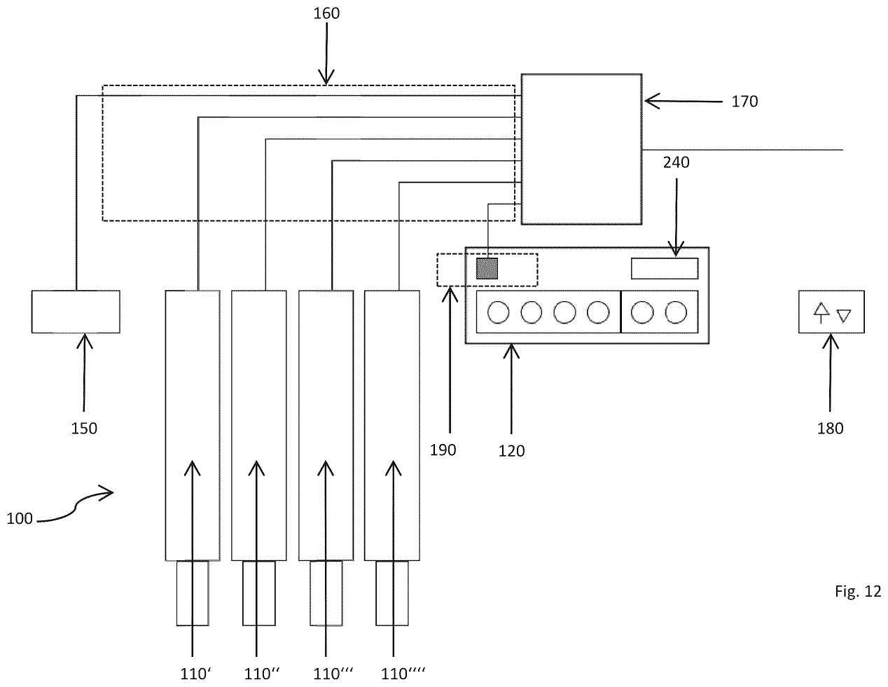

FIG. 12 a furniture system with an internal network having a star topology, wherein the power distributor is connected to a central motor control;

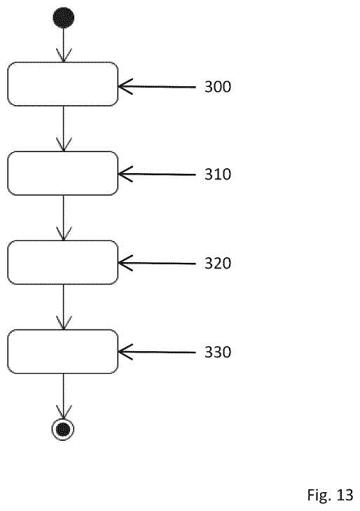

FIG. 13 a method for power distribution; and

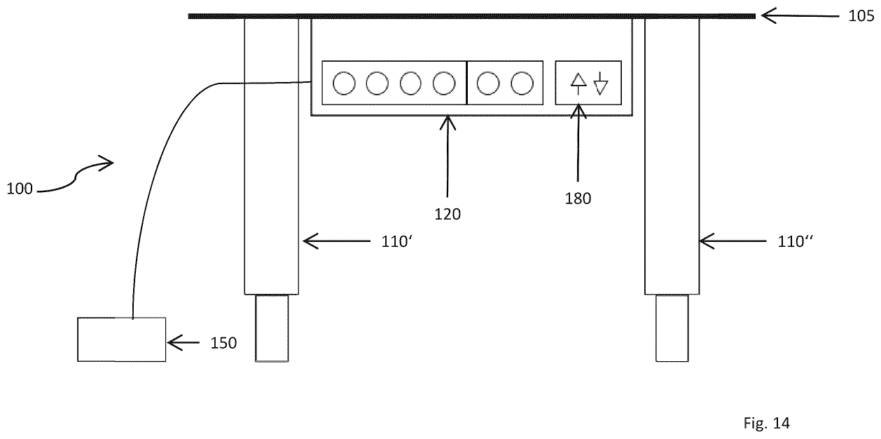

FIG. 14 a furniture system with an electrically adjustable furniture part.

FIG. 1 shows a furniture system 100 with a bidirectional power distributor 120 with further components for electrical adjustment of parts of the furniture system. The furniture system 100 comprises an internal power supply unit 150, a handswitch 180 and one or more linear actuators 110′, 110″, 110′″, 110″″. In the specific embodiment example, four linear actuators can be seen for four table legs of a table, or two table legs of two combined tables. The linear actuators 110′, 110″, 110′″, 110″″ can each have a motor controller 170′, 170″, 170′″, 170″″, for example. Alternatively, there may also be a central motor control unit that controls several linear actuators (not shown).

The furniture system 100 further comprises, for example, an internal, furniture system network 160, which has at least lines for power supply, but also lines for data communication between the components. An embodiment example of a bus for data communication is a LIN bus.

In FIG. 1, the power distributor 120 has, for example, a group with one or more internal interfaces 190 to the internal network 160.

The network shown in FIG. 1 is, for example, a network in star topology, with the power distributor being a central component to which other furniture system components are connected.

In FIG. 1, the power distributor 120 has, for example, a group with one or more unidirectional interfaces 130 and a group with one or more bidirectional interfaces 140 as external interfaces to which various external components are connected.

In one example embodiment, both the group of unidirectional interfaces 130 and the group of bidirectional interfaces 140 can be realized as USB ports. A port is an external interface to which further devices can be connected with a cable, for example via a corresponding plug.

FIG. 2 shows a situation in which the furniture system 100 receives no power from the furniture's own power supply unit, for example because it is not connected or defective or is unable to draw any voltage from the mains. An energy storage device 210, e.g. a battery, and another energy source 220, e.g. a power supply unit of a portable computer, are connected to the external bidirectional interfaces 140. Furthermore, a load 200 is connected to one of the external unidirectional interfaces 130.

The power distributor 120 now decides, for example, that power is required for the linear actuators due to a command, for example via the handswitch 180, to move the piece of furniture. It therefore switches the direction of the two energy flows E1 and E2 of the two energy sources 210 and 220 in the direction of the piece of furniture and directs the combined energy flow E1+E2 to the linear actuators.

FIG. 3 shows a situation in which the furniture system 100 is supplied by the power supply unit 150 as well as by an energy storage device 210 and another energy source 220. The energy flow E3 from the power supply unit 150 and the two energy flows E1 and E2 add up, as the power supply unit 150, energy storage device 210 and energy source 220 are combined.

FIG. 4 shows a situation in which a consumer 200 is supplied with energy from energy flow E3 from the power supply unit 150. For example, this could be a mobile device with a built-in battery that is connected to the furniture system 100 via the power distributor 120 and is now being charged via the furniture system.

FIG. 5 shows a situation in which—analogous to the situation in FIG. 4—a consumer is supplied with the energy from energy flow E3 from the furniture's own power supply unit 150. For example, an energy storage device 210 connected to one of the bidirectional interfaces 140 is charged with the energy from energy flow E3 from the power supply unit. In one embodiment, this may be a battery in a laptop, which is charged and which in turn is used to power the furniture system at a later time.

FIG. 6 shows the situation in which the energy storage device 210 in a mobile device, which is connected to the furniture system 100 via a bidirectional interface of the power distribution unit 120, feeds a load 200, which is connected to a unidirectional interface of the power distribution unit 120, with energy from energy flow E2.

In another embodiment (not shown), only a portion of the energy from energy flow E2 can also be supplied to the load 200 and another portion can feed other loads or the components for electrical adjustment.

FIG. 7 shows the situation in which an energy storage device 210, which is connected to a first bidirectional interface, supplies a consumer 220, which is connected to a second bidirectional interface, with energy from energy flow E2.

FIGS. 8a, 8b show situations in which the potential energy contained in an adjustable part of the furniture system, for example in a raised tabletop, serves as an energy source for an energy storage device. For example, when the tabletop moves downwards, the potential energy released is not destroyed by active braking, e.g. in the form of thermal energy, but is converted into electrical energy by the motors operated in generator mode in the linear actuators 110′, 110″, 110′″, 110′″ of the table columns, which is supplied to an energy storage device by the power distributor. The energy storage device may, for example, be integrated in the power distributor (230 in FIG. 8a), connected to an external interface of the power distributor (210 in FIG. 8b), or connected to the internal network of the furniture system (not shown).

In the previous embodiments, mainly situations were shown in which an energy source supplied another consumer with power. It is of course also possible for the power of one or more energy sources to be distributed to several consumers. For example, the power distributor could negotiate contracts with several consumers that define which power is supplied per consumer.

FIG. 9 shows one embodiment of a furniture system 100 in which the internal network 160 has a line topology. The power distributor is connected to the internal network 160 via an internal interface 190. Similarly, the internal power supply unit 150 and the linear actuators 110′, 110″, 110′″, 110″″ with the corresponding motor controllers 170′, 170″, 170′″, 170″″ are connected to the internal network 160.

In the embodiment shown in FIG. 9, the power distributor 120 comprises a handswitch 180 integrated in the power distributor,

Alternatively, a handswitch comprises a power distributor integrated into the handswitch.

Alternatively, the handswitch and power distributor may be independent components, each connected to the internal network 160.

FIG. 10 shows an embodiment of a furniture system 100 with a power distributor 120 having a group of internal interfaces 190 with two interfaces. The internal network has a line topology. A handswitch is connected to one of the interfaces of the group of interfaces 190.

The power distributor connects the two interfaces of the interface group 190 internally. The controller unit 240 is also connected to the internal network (not shown).

Alternatively, the handswitch can be integrated in the power distributor.

FIG. 11 shows an embodiment of a furniture system 100 with a power distributor 120 and an internal network 160 in star topology. The internal power supply unit 150 and the linear actuators with the respective motor controllers are each connected to an interface of the interface group 190.

The handswitch 180 can be integrated in the power distributor 120 (as shown in FIG. 11), or can be connected independently at its own interface to one of the interfaces of the interface group 190 of the power distributor 120.

The controller unit 240 is also connected to the internal network 160 in the power distributor.

FIG. 12 shows an embodiment of a furniture system 100 which, in contrast to the embodiments shown so far, has a central motor controller 170 instead of the motor controllers 170′, 170″, 170′″, 170″″ integrated in the linear actuators. The internal network 160 has a star topology. The linear actuators 110′, 110″, 110′″, 110″″ as well as a handswitch 180, the internal power supply unit 150 and the power distributor 120 are connected to the internal network 160.

Alternatively, the handswitch 180 may be integrated in the power distributor 120.

FIG. 13 shows a method for power distribution in a furniture system 100.

For example, a load situation may arise when adjusting parts of the furniture system, which results in a total power demand that can no longer be met by the internal power supply unit. In contrast to the state of the art, the adjustment is now not terminated, but a check is made to see whether power is available from external power sources that can compensate for the missing power. If the sum of the power from external power sources and the power of the internal power supply unit is sufficient, the power from the external power sources is fed in, and the adjustment is continued. If the sum of the power is not sufficient, the adjustment stops.

The method therefore comprises the following steps:
a. Determining (300) a momentary total power demand of all consumers connected to the internal network, in particular the components for electrical adjustment of the table system,
b. Determining (310) an available power from the internal power supply unit,
c. Determining (320) an available power from one or more connected external power sources,
d. Supplying (330) the loads connected to the internal network (160) with combined power from the internal power supply unit (150) and from the connected external power sources (210) if the determined available power from the internal power supply unit (150) is lower than the determined total power demand and if a sum of the determined available power from the internal power supply unit (150) and the external power sources (210) is higher than the determined total power demand.

The method can be repeated cyclically, for example in order to detect a lack of power during an adjustment of parts of the furniture system and then, if available, to feed in power from external power sources.

FIG. 14 shows an embodiment of a furniture system 100 with an electrically adjustable furniture part in the form of a tabletop 105, which can be electrically adjusted by a plurality of linear actuators 110′, 110″. An internal power supply unit 150 is connected to a power distributor 120, which in this example is mounted on the tabletop 105 and comprises an integrated handswitch 180.

Reference symbol list

| | |
|---|---|
| 100 | furniture system |
| 105 | electrically adjustable furniture part |
| 110′, 110″, 110′″, 110″″ | linear actuators |
| 120 | power distributor |
| 130 | unidirectional interface |
| 140 | bidirectional interface |
| 150 | internal power supply unit |
| 160 | internal network |
| 170, 170′, 170″, 170″′, 170″″ | motor control |
| 180 | manual switch |
| 190 | internal interfaces |
| 200 | consumer |
| 210 | external power source |
| 220 | external power source |
| 230 | energy storage |
| 240 | controller unit |
| E1, E2, E3, E1 + E2, E1 + E2 + E3 | energy flows |
| 300-330 | method steps |

1. A furniture system with at least one electrically adjustable part, comprising
one or more components for electrical adjustment of the at least one electrically adjustable part
at least one internal power supply unit;
an internal network for connecting the one or more components; and
a power distributor, wherein the power distributor comprises:
at least one internal interface to the internal network;
at least one external interface for connecting an external power source, wherein the at least one external interface each has one or more lines for power supply; and
a controller unit, which is configured for demand-dependent control of one or more energy flows between the internal power supply unit, the internal network and the at least one external interface;
wherein the power distributor is configured, in particular through the controller unit, to selectively supply the components for electrical adjustment from the following, both individually and in combination:
from the internal power supply unit; and
from the external power source when the external power source is connected to the at least one external interface.

2. The furniture system according to claim 1, wherein the power distributor comprises at least one further external interface for connecting a further external power source and is arranged to supply the components for electrical adjustment additionally or alternatively from the further external power source when the further external power source is connected to the at least one further external interface.

3. The furniture system according to claim 1, wherein
the furniture system comprises an electrical energy storage, in particular for receiving potential energy of the at least one adjustable part; and
the power distributor is configured to supply the components for electrical adjustment additionally or alternatively from the energy storage.

4. The furniture system according to claim 3, wherein the power distributor is configured to supply the energy storage from potential energy of the at least one adjustable part.

5. The furniture system according to claim 1, wherein the at least one external interface and/or, when present, the at least one further external interface are configured as a bidirectional interface.

6. The furniture system according to claim 5, wherein a direction of an energy flow is adjustable for each of the bidirectional interfaces.

7. The furniture system according to claim 5, wherein a level of an energy flow is adjustable for each of the bidirectional interfaces.

8. The furniture system according to claim 5, wherein the power distributor is configured to supply at least one load connected to one of the bidirectional interfaces from at least one of the following:
the internal power supply unit
the external power source, when the external power source is connected to the at least one external interface;
potential energy of the at least one adjustable part.

9. The furniture system according to claim 1, wherein the power distributor further comprises at least one unidirectional interface and is arranged to supply at least one load connected to one of the at least one unidirectional interface from at least one of the following:
the internal power supply unit
the external power source, if the external power source is connected to the at least one external interface;
potential energy of the at least one adjustable part.

10. The furniture system according to claim 9, wherein a level of an energy flow for the at least one unidirectional interface is adjustable.

11. The furniture system according to claim 1, wherein the power distributor is arranged to negotiate a level and/or a direction of the energy flow by means of a data communication, in particular via a data line, with a connected external power source and/or a connected load.

12. The furniture system according to claim 1, wherein the controller unit is configured to supply the components for electrical adjustment with power from a combination of power from the internal power supply unit and power from at least one connected external power source when the controller unit determines that the power of the internal power supply unit is insufficient for a loading situation of the at least one adjustable part of the furniture system.

13. The furniture system according to claim 1, wherein the power distributor is configured to connect an external energy storage device and/or an external power supply unit as an external power source.

14. The furniture system according to claim 1, wherein the internal network comprises lines for supplying power to the one or more components and lines for data communication between the power distributor and the one or more components and between multiple components.

15. A method for power distribution in a furniture system according claim 1, the method comprising:
determining a momentary total power demand of all loads connected to the internal network, in particular the components for electrical adjustment of the table system,
determining an available power from the internal power supply unit,
determining an available power from one or more connected external power sources, and
supplying the loads connected to the internal network with combined power from the internal power supply unit and from the connected external power sources if the determined available power from the internal power supply unit s is lower than the determined total power demand and if a sum of the determined available power from the internal power supply unit and the external power sources is higher than the determined total power demand.
